(19) United States
(12) Patent Application Publication
(10) Pub. No.: US 2006/0187872 A1
(43) Pub. Date: Aug. 24, 2006

(54) Multiaccess techniques for mobile and stationary cellular communications

(76) Inventor: Mark James Rich, Menlo Park, CA (US)

Correspondence Address: PATENTRY, 300 MURCHISON DRIVE, SUITE 218, MILLBRAE, CA, 94030, US

(21) Appl. No.: 10/906,454

(22) Filed: Feb. 21, 2005

(51) Int. Cl. H04Q 7/00

(52) U.S. Cl. 370/328

(57) ABSTRACT

A wireless communications system connecting multiple senders and multiple receivers through multi-access method utilizing orthogonal frequency division multiplexing techniques. A method of expanding the services provided by delivering asymmetrically higher bandwidth per channel and more channels through orthogonal frequency division multiplexed access methods and quadrature amplitude modulation.

### BACKGROUND OF THE INVENTION

Globally, a variety of techniques have enabled ubiquitous mobile telephone service providing voice communications initially through analog and later digital means. While cellular modularity allowed the linear increase of capacity by adding additional base stations, at some point all economical physical locations in a region are populated with cell towers. Carriers are dynamically assigned to cell stations to allow overlapping service areas. Dynamic assignment provides more efficient use of the spectrum when several base stations operating in a region have different subscriber station loads.

Problem

Reflecting the dramatic lowering of cost of consumer digital electronics products, mobile and handheld systems have much more computational power and capacity for storage enabling music, and video capabilities. But the bandwidth available to deliver such content has not expanded at the same rate limiting the usefulness and adoption of content intense applications. Several factors can decrease the capacity per base station. All of the carriers might not be able to be put into use if the carriers are inefficiently allocated. Things that might cause inefficient allocation include software limitations, imbalance loading between cellular stations or coverage areas that do not approximate the hexagonal packing model.

In order to deliver more capacity to each customer, either the capacity per base station must be increased or the number of customers per base station must be decreased. The later factor is an issue of economics because this would require adding more base stations to a geographical area, a problem with cost and logistics issues. Thus it can be seen that what is needed is an improvement in increasing the capacity of a base station.

A complicating factor is that any proposed modification to a conventional system must co-exist with other provider's systems operating in the same band. For example, if cell systems of the prior art are deployed, channels must be set aside and protected for the legacy equipment. Additionally, if interoperation of new equipment and legacy equipment is desired, then compatible modulation such as Quardrature Phase Shift Key (QPSK) modulation and signaling must be provided by the new system.

### SUMMARY OF THE INVENTION

Two dimensions exist for increasing the capacity of a wireless communications system without increasing the spectrum allocation. The modulation complexity can be increased to provide more information in each transmitted symbol and the spacing between carriers can be decreased to provide more carriers. The present invention adds capacity by simultaneously improving in both dimensions.

The present invention uses an orthogonal frequency division multiple access technique (OFDMA), to synchronize a plurality of RF carriers, allowing them to be more closely spaced and allowing an increase in the system capacity. This further facilitates the adoption of higher order quadrature amplitude modulation (QAM) to increase system capacity. OFDMA can use higher order QAM to provide more bits per symbol than the current 2 bits per symbol used in QPSK modulation. QAM modulation thereby increases symbol complexity and increases capacity as well. Carrier modulation can be coded to allow mixed symbol complexities, increasing the efficiency of the technique. An advantage of the present invention is that a reduced carrier spacing equal to the symbol rate can be used if the carriers are synchronized.

In the present invention the OFDMA technique applies differently in the forward and reverse directions. It is easier to synchronize the carriers in the forward direction because all of the carriers are modulated by the same source, the reverse link requires greater use of time division access because it is difficult to synchronize the transmissions from several subscriber units which may be moving, at varying distance from their base station, and rely on low quality clocks. The forward link needs to make provisions for multiple base stations to be operating in a geographic area and to allow a subscriber station to receive signals from multiple base stations simultaneously.

### DESCRIPTION OF THE FIGURES

FIG. 1 is orthogonal views of the forward channel concept in exploded scales and dimensions.

FIG. 2 is a schematic of the reverse channel concept in frequency (vertical) and time (horizontal).

### DETAILED DESCRIPTION

The present invention is a cellular communication system comprising a cellular infrastructure, a plurality of subscriber stations, a channel assignment method, a forward link method for broadcasting allocations of timeslots and spectrum to the subscriber stations, and a reverse link method for modulating multiple carriers by each subscriber station.

The reverse link method enables each subscriber station to transmit during an assigned time slot on a plurality of assigned carriers using orthogonal frequency division multiplexing access method. By combining time slots a subscriber station may increase efficiency by eliminating gaps. Transmitting on adjacent orthogonal frequency division multiplexing carrier bands increases efficiency by eliminating overhead carriers.

The channel assignment method of the present invention divides up time and spectrum to a plurality of timeslots each containing carriers in a plurality of frequency bands. Each subscriber station is assigned to a unique time slot and plurality of carriers. It is possible to combine timeslots to increase transmission efficiency by eliminating time gaps. Combining adjacent frequency assignments increases transmission efficiency by eliminating overhead carriers.

The forward link method includes firstly broadcasting allocations of timeslots and spectrum to the subscriber stations, secondly, modulating data on a plurality of synchronized carriers using quadrature amplitude modulations, and thirdly, transmitting data on multiple carriers using orthogonal frequency division multiplexing.

The forward link method operates in the beginning portion of a frame, consisting of a first part and a second part. During the first part of a cell station transmission, each cell station transmits training and synchronization information first sending multiple tones of pure carrier to allow receivers to adjust their reference frequency, secondly sending a special sequence to allow each receiver to update equalization coefficients, thirdly broadcasting timing and identification information for new stations joining the network, and fourth sending information indicating what timeslots are assigned to specific personal stations, wherein each cell station is assigned a fraction of the band commensurate with the amount of forward traffic it needs to send.

The subscriber stations that only receive data comprise a quadrature amplitude demodulator, and an orthogonal frequency division multiplexing receiver. Two way subscriber stations further comprise a quadrature phase shift key modulator and an orthogonal frequency division multiplexing transmitter.

The cellular infrastructure includes physically distributed base stations wherein the coverage of signals is overlapping, an access method for orthogonal frequency division multiplexing wherein adjacent base stations may use carriers in common without interference, a plurality of encoding modulation methods, and a duplex method of time division wherein a plurality of timeslots may be combined for efficiency.

By dividing each time frame into a forward portion of a time frame and a reverse portion of a time frame frequency allocations for transmission from base stations to subscriber stations are reused in the transmission from subscriber stations to base stations which thereby improves efficiency by using more frequencies at any point in time.

The duplex method also divides each time frame into a plurality of time slots which are allocated to transmit to subscriber stations and to transmit from subscriber stations to base stations, the timeslots allowing combination of a plurality of timeslots into one transmission wherein the removal of gaps between timeslots and use of a single header for a combined timeslot improves the efficiency of transmission by replacing gaps and headers with data. The duplex method uses the best of quadrature amplitude modulation encoding and quadrature phase shift key modulation encoding wherein the more data intensive direction may use a more complex and costly transmission modulation and the less data intensive direction may use a compact and economical transmission modulation.

By assigning a plurality of carriers to the transmission from a first base station to a first subscriber station wherein the combination of carriers is not identically used by a second base station adjacent to the first base station to transmit to a second subscriber station the present invention increases the efficiency of using the available spectrum by allowing adjacent base stations to transmit on closely spaced carriers. By dividing the spectrum available to base stations into frequency bands and assigning the carriers available in a plurality of frequency bands to a single transmission, the present invention increases the use of spectrum by reducing the number of overhead carriers or more closely spacing carriers for a single higher bandwidth transmission. The number of carriers assigned to depends upon the communications load required of that base station.

The cellular infrastructure transmits synchronization information from a plurality of base stations to a plurality of subscriber stations during the forward link allowing the subscriber stations to determine which base station has a stronger signal and self select which base station it should associate with. By dividing time and pluralities of orthogonal carriers into a large number of combinations the present invention creates a larger number of simultaneous communication opportunities from subscriber stations to base stations.

The present invention is compatible with and may be used to upgrade present mobile radio system including but not limited to personal handyphone system, land mobile radio, police radio, tdma cellular system, and two way paging. For example, a cellular telephone system may consist of a conventional personal handyphone system infrastructure, base stations, subscriber stations, a time division duplex system, an orthogonal frequency division multiplexing access method forward link and an orthogonal frequency division access reverse link.

In the example of upgrading a personal handyphone system the standard timeslots consist of 16 symbols, 8 symbols of synchronization and header information followed by 8 symbols of traffic and double timeslots eliminate one guardtime interval and use a single header to deliver up to 25 symbols, wherein a total of 28 single slot or 14 double slots or a mixture of the two are allowed in a 2.5 ms reverse link interval.

A higher bandwidth personal handyphone system might use 5 carriers to carry a 32 kbps transmission wherein some number of carriers are set aside for interference mitigation and using 8 symbols every 2.5 ms, wherein restricting operation to quadrature phase shift keying modulation provides 2 bits per symbol per carrier to carry the traffic and additional carriers are used for synchronization and isolation between adjacent, unsynchronized subscriber station transmissions.

An example of using the invention in a personal handyphone system could provide an 8 symbol payload in the standard timeslot and use four carriers to increase the volume of information delivered. For higher data rates, an example of the invention would be a personal handyphone system delivering a 25 symbol payload in the double timeslot and using four carriers wherein efficiency is increased because a single traffic header is used and because the interslot guard time is eliminated.

The forward link broadcasts training and synchronization information and payload. Training and synchronization information consists of multiple tones of pure carrier to allow receivers to adjust their reference frequency, a special sequence to allow each receiver to update equalization coefficients, timing and identification information for new stations joining the network, and information indicating what timeslots are assigned to specific personal stations, wherein each cell station is assigned a fraction of the band commensurate with the amount of forward traffic it needs to send.

In the present invention subscriber stations synchronize to base stations by simultaneously demodulating the entire band, during the pure tone transmission, to select the cell station with the best signal strength if it has not been in prior communication with a specific cell station, wherein new entrants to the network will scan until the training sequence is detected.

By continuing to monitor the training sequences of other base stations in the area, the subscriber station itself makes hand-off decisions as it moves from one cell coverage area to another.

The present invention enables a base station to economically transmit data in quadrature amplitude modulation (QAM) on the forward link in the authorized portions of the spectrum to further increase forward link capacity.

### Forward Link Example

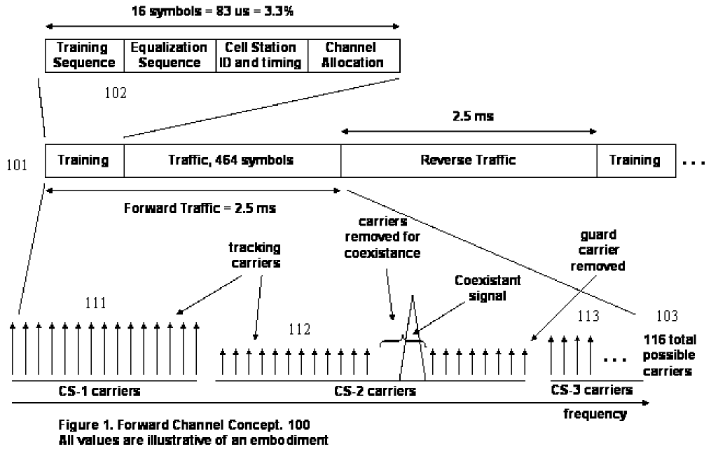

FIG. 1 illustrates the forward link concept 100. The time division duplex (TDD) protocol 101 allows the forward link (CellStation to PersonalStation) to operate for the first 2.5 ms portion of a frame. The reverse link, discussed in the next section operates in the last 2.5 ms portion of a frame. A Cell Station (CS) transmission is divided into two parts. There is a periodic training sequence 102 where each CS will transmit training and synchronization information. Each CS is assigned a fraction of the band 103 commensurate with the amount of forward traffic it needs to send. First, each CS sends multiple tones of pure carrier to allow receivers to adjust their reference frequency. Next, a special sequence is transmitted to allow each receiver to update equalization coefficients. The CS then broadcasts timing and identification information for new stations joining the network. Finally, the CS transmits information indicating what timeslots are assigned to specific Personal Stations (PS). Each PS can simultaneously demodulate the entire band. A PS either demodulates only the CS to which it is assigned or, during the pure tone transmission, the PS can select the CS with the best signal strength if it has not been in prior communication with a specific CS. New entrants to the network will scan until the training sequence is detected. The training sequence is shortened for efficiency so it may require a couple of successive training sequences for a new entrant to complete synchronization.

Once a PS is synchronized, it continues to monitor the training sequences 102 of other CS in the area. This will allow the PS itself to make hand-off decisions as it moves from one CS coverage area to another.

As shown in FIG. 1, in one embodiment 3.3% of the forward link capacity is consumed by the header 102. Tones used for spacing between CS transmissions and tones used for synchronization also reduce the system capacity. Finally, any tones set aside for interference mitigation reduce the capacity of a specific PS.

FIG. 1 shows 3 simultaneous CS in operation 103 each transmitting on a plurality of carriers 111, 112, 113, a typical scenario. A worst case scenario would require 7 simultaneous CS and would set aside 24 carriers for overhead (20.7%). Total forward link overhead is 24%. Even in this worst case scenario, the OFDM approach provides 31% more forward link capacity than conventional systems. QAM modulation can be used on the forward link in the authorized portions of the spectrum to further increase forward link capacity

### Reverse Link Example

The reverse link is more difficult to synchronize because the PS's transmissions can only be coarsely aligned. Each PS will synchronize to the timing of the forward link transmission from the best CS. Transmission time of flight may vary over 1 km between the closest and the farthest PS. One-way time differences could be as much as 5 us. This is illustrated in figure two with the non-uniform start times of the headers in the horizontal dimension.

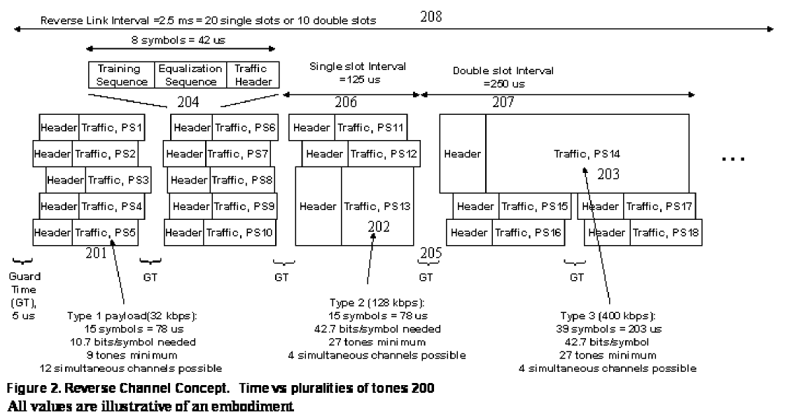

There are two possible solutions; the simplest is to include a guard time between PS transmissions large enough to ensure no overlap. The second is to track out time of flight and reduce the guard time and increase reverse channel efficiency. The later is problematic, multiple CS will receive PS transmissions and the geographic separation makes it impossible to track out time of flight to all potential receivers. The former approach is illustrated in FIG. 2 200.

Each PS is assigned a portion of the spectrum so multiple PS transmissions are “stacked” in frequency as illustrated in the vertical dimension of FIG. 2 200. In the notional example shown in FIG. 2, a standard time slot 206 will consist of 16 symbols, 8 symbols of synchronization and header information followed by 8 symbols of traffic. A double timeslot 207 is also allowed. The elimination of one guard time interval 205 and the use of a single header allows 25 symbols to be delivered in a double slot. A total of 28 single slot or 14 double slots or a mixture of the two are allowed in a 2.5 ms reverse link interval 208.

Some number of tones are set aside for interference mitigation. In the FIG. 2 example we assume that 20% of the band is reserved for contention with other personal handyphone system operation. In order to deliver 32 kbps service using 8 symbols every 2.5 ms, our signaling efficiency needs to be 10 bits per symbol. Restricting operation to QPSK modulation 209 (to reduce the PS linearity requirements) provides 2 bits per symbol per carrier so a minimum of 5 carriers is needed to carry the traffic. Additional carriers are used for synchronization and isolation between adjacent, unsynchronized PS transmissions. We assume 5 tones are used to carry a 32 kbps transmission 201.

Higher rate transmissions are carried in two ways. A 128 kbps service 202 is provided by using the same duration slot (an 8 symbol payload) but using more carriers to increase the volume of information delivered. This is more efficient because the number of overhead tones used to carry 32 kbps traffic (three tones) only needs to be increased slightly to carry 128 kbps data (to four tones). We can deliver 4× the bandwidth using 3× the resources (number of tones).

Highest rate transmissions 203 would also use the technique of increasing the number of tones but would also increase the duration of the payload. To allow compatibility with other types of payloads, we assume the highest data rate would use a double size time slot 207. Efficiency is increased because a single traffic header is used and because the interslot guard time 205 is eliminated. More than 3× the data is delivered (400 kbps vs 128 kbps) using only 2× the communication resource.

The reverse link is limited to QPSK so that low cost, low power transmitters can be used in the PS equipment. Voice services are symmetrical and the same number of channels is needed in each direction. Data services may be asymmetrical, delivering more data to the PS, and more data channels may be needed in the forward link to support receive only PS devices. The forward link is less sensitive to the cost and linearity of the transmit equipment and requires less overhead for synchronization. Higher order modulations, up to 64 QAM, could be used in the forward link.

In an embodiment, forward link signaling occurs at 192 ksym/sec. Using QPSK modulation on 108 tones and assuming 24% overhead for synchronization header and tracking tones results in a raw rate of 31.5 Mbps. Increasing the modulation to 64-QAM provides a raw rate of 94.5 Mbps if QAM was allowed to be used in the entire spectrum. Since current regulations only allow QAM to be used in 9 MHz of the spectrum, the maximum that could be delivered is approximately 56 Mbps. Error control coding has not been included, error control overhead will need to be subtracted from delivered capacity.

Only 11.6 Mbps is needed to provide the maximum number of voice channels available in the reverse link (364) so if only voice traffic is to be provided, there is no need to use more than QPSK modulation and significant excess capacity remains for other forward link services. If 56 high rate data channels (400 kbps) are used (the limit in the reverse link), 1.0 Mbps could be delivered to each PS on the same number of forward link channels. Contention with other service providers and coexistence rules will reduce the spectrum available in each geographic area. The OFDM approach scales well and can be dynamically adjusted by restricting the tones in use. The number of channels that can be provided by the OFDM approach will scale with spectrum availability. The services provided will be the same. One embodiment uses the same symbol rate as is in use today (192 ksym/sec) which would allow up to 116 carriers but several carriers would be restricted. Carriers at the edge of the band are not used to decrease interference with adjacent bands. One carrier is removed from the center to simplify the radio requirements (improved LO isolation) and additional carriers are removed to provide isolation between blocks of carriers originating from different transmitters. Carriers are restricted and not used on a site by site basis to eliminate interference with other systems operating in the area. The number of carriers removed depend upon the amount of traffic carried on other systems and are dynamically adjusted. There are 116 possible carriers, 108 are typically used but many of these may be restricted to ensure compatibility with existing conventional PHS systems.

The foregoing description of the embodiments of the invention are to be considered in all respects as illustrative and not restrictive, the scope of the invention being indicated by the appended claims rather than by the foregoing description, and all changes that come within the meaning and range of equivalency of the claims therefore are intended to be embraced therein. The embodiment described is selected to best explain the principles of the invention and its practical application to thereby enable others skilled in the art to best utilize the invention in various embodiments and with various modifications as suited to the particular purpose contemplated. In particular, applicant contemplates that functional implementation of invention described herein may be implemented equivalently in hardware, software, firmware, and/or other available functional components or building blocks. Other variations and embodiments are possible in light of the above teachings, and it is thus intended that the scope of the invention reflect the following claims.

What is claimed is:

1. A cellular communication system comprising a cellular infrastructure, a plurality of subscriber stations, a channel assignment method, a forward link method for broadcasting allocations of timeslots and spectrum to the subscriber stations, and a reverse link method for modulating multiple carriers by each subscriber station.

2. The reverse link method of claim one comprising transmitting during an assigned time slot on a plurality of assigned carriers using orthogonal frequency division multiplexing access method.

3. The reverse link method of claim two further comprising combining time slots to increase efficiency by eliminating gaps, and transmitting on adjacent orthogonal frequency division multiplexing carrier bands to increase efficiency by eliminating overhead carriers.

4. The channel assignment method of claim one comprising the steps of firstly dividing up time and spectrum to a plurality of timeslots each containing carriers in a plurality of frequency bands, secondly assigning each subscriber station to a unique time slot and plurality of carriers, thirdly, combining timeslots to increase transmission efficiency by eliminating time gaps, and fourthly combining adjacent frequency assignments to increase transmission efficiency by eliminating overhead carriers.

5. The forward link method of claim four further comprising firstly broadcasting allocations of timeslots and spectrum to the subscriber stations, secondly, modulating data on a plurality of synchronized carriers using quadrature amplitude modulations, and thirdly, transmitting data on multiple carriers using orthogonal frequency division multiplexing.

6. The forward link method of claim four, operating in the beginning portion of a frame, further comprising a first part and a second part, said first part of a cell station transmission where each cell station transmits training and synchronization information comprising sending multiple tones of pure carrier to allow receivers to adjust their reference frequency, secondly sending a special sequence to allow each receiver to update equalization coefficients, thirdly broadcasting timing and identification information for new stations joining the network, and fourth sending information indicating what timeslots are assigned to specific personal stations, wherein each cell station is assigned a fraction of the band commensurate with the amount of forward traffic it needs to send.

7. The subscriber station of claim one comprising a quadrature amplitude demodulator, and an orthogonal frequency division multiplexing receiver.

8. The subscriber station of claim seven further comprising a quadrature phase shift key modulator and an orthogonal frequency division multiplexing transmitter.

9. The cellular infrastructure of claim one comprising a plurality of physically distributed base stations wherein the coverage of signals is overlapping, an access method for orthogonal frequency division multiplexing wherein adjacent base stations may use carriers without interference, a plurality of encoding modulation methods, and a duplex method of time division wherein a plurality of timeslots may be combined for efficiency.

10. The duplex method of claim nine comprising dividing each time frame into a forward portion of a time frame and a reverse portion of a time frame enabling the reuse of frequency allocations in the transmission from base stations to subscriber stations and in the transmission from subscriber stations to base stations which thereby improves efficiency by using more frequencies at any point in time.

11. The duplex method of claim nine further comprising dividing each time frame into a plurality of time slots which are allocated to transmit to subscriber stations and to transmit from subscriber stations to base stations, the timeslots allowing combination of a plurality of timeslots into one transmission wherein the removal of gaps between timeslots and use of a single header for a combined timeslot improves the efficiency of transmission by replacing gaps and headers with data.

12. The duplex method of claim nine further comprising quadrature amplitude modulation encoding and quadrature phase shift key modulation encoding wherein the more data intensive direction may use a more complex and costly transmission modulation and the less data intensive direction may use a compact and economical transmission modulation.

13. The access method of claim nine comprising assigning a plurality of carriers to the transmission from a first base station to a first subscriber station wherein the carriers are not used by a second base station adjacent to the first base station to transmit to a second subscriber station increasing the efficiency of using the available spectrum by allowing adjacent base stations to transmit on closely spaced carriers.

14. The access method of claim nine comprising dividing the spectrum available to a base station into frequency bands and assigning the carriers available in a plurality of frequency bands to a single transmission increasing the use of spectrum by reducing the number of overhead carriers or more closely spacing carriers for a single higher bandwidth transmission.

15. The cellular infrastructure of claim nine further comprising transmission of synchronization information from a plurality of base stations to a plurality of subscriber stations during the forward link allowing the subscriber stations to determine which base station has a stronger signal and self select which base station it should associate with.

16. The cellular infrastructure of claim nine further comprising a method to divide time and pluralities of orthogonal carriers into a large number of combinations creating a larger number of simultaneous communication opportunities from subscriber stations to base stations.

17. The cellular communications system of claim one further comprising a mobile radio communications network infrastructure selected from among the following: personal handyphone system, land mobile radio, police radio, tdma cellular system, and two way paging.

18. A cellular telephone system comprising a conventional personal handyphone system infrastructure, base stations, subscriber stations, a time division duplex system, an orthogonal frequency division multiplexing access method forward link and an orthogonal frequency division access reverse link.

19. The duplex system of claim eighteen comprised of standard timeslots consisting of 16 symbols, 8 symbols of synchronization and header information followed by 8 symbols of traffic and double timeslots, wherein eliminating one guardtime interval and the use of a single header allows up to 25 symbols, wherein a total of 28 single slot or 14 double slots or a mixture of the two are allowed in a 2.5 ms reverse link interval.

20. The access method of claim eighteen using 5 carriers to carry a 32 kbps transmission wherein some number of carriers are set aside for interference mitigation and using 8 symbols every 2.5 ms, wherein restricting operation to quadrature phase shift keying modulation provides 2 bits per symbol per carrier to carry the traffic and additional carriers are used for synchronization and isolation between adjacent, unsynchronized subscriber station transmissions.

21. The system of claim eighteen further comprising an 8 symbol payload in the standard timeslot and using four carriers to increase the volume of information delivered.

22. The system of claim eighteen further comprising a 25 symbol payload in the double timeslot and using four carriers wherein efficiency is increased because a single traffic header is used and because the interslot guard time is eliminated.

23. The forward link of claim eighteen further comprising training and synchronization information and payload, said training and synchronization information comprising multiple tones of pure carrier to allow receivers to adjust their reference frequency, secondly a special sequence to allow each receiver to update equalization coefficients, thirdly timing and identification information for new stations joining the network, and fourth information indicating what timeslots are assigned to specific personal stations, wherein each cell station is assigned a fraction of the band commensurate with the amount of forward traffic it needs to send.

24. A process of synchronizing a subscriber station to base stations, the steps comprising: simultaneously demodulating the entire band, during the pure tone transmission, to select the cell station with the best signal strength if it has not been in prior communication with a specific cell station, wherein new entrants to the network will scan until the training sequence is detected.

25. The process of claim twenty-four further consisting of continuing to monitor the training sequences of other base stations in the area, wherein said monitoring allows the subscriber station itself to make hand-off decisions as it moves from one cell coverage area to another.

26. The system of claim eighteen further comprising a base station transmitting data in quadrature amplitude modulation on the forward link in the authorized portions of the spectrum to further increase forward link capacity.
